(19) United States
(12) Patent Application Publication
(10) Pub. No.: US 2021/0284340 A1
(43) Pub. Date: Sep. 16, 2021

(54) AIRCRAFT GALLEY UNIT

(71) Applicant: AIM ALTITUDE UK LTD, Christchurch (GB)

(72) Inventors: Ross Burns, Christchurch (GB); Helena Teichrib, Christchurch (GB)

(21) Appl. No.: 16/820,234

(22) Filed: Mar. 16, 2020

(51) Int. Cl. B64D 11/04

(52) U.S. Cl. CPC B64D 11/04

(57) ABSTRACT

An aircraft galley unit comprising a compartment configured to receive airline cart food containers, wherein a shape and size of the compartment is such that the airline cart food containers are vertically arrangeable in the compartment and sit flush against the walls of the compartment.

### BACKGROUND

### Field of the Disclosure

The present disclosure relates to an aircraft galley unit.

### Description of the Related Art

The “background” description provided is for the purpose of generally presenting the context of the disclosure. Work of the presently named inventors, to the extent it is described in the background section, as well as aspects of the description which may not otherwise qualify as prior art at the time of filing, are neither expressly or impliedly admitted as prior art against the present disclosure.

There is growing demand for air travel and, as a result, airlines desire to increase the seating capacity of existing aircraft. The space available on an aircraft is limited and an aircraft must carry suitable equipment for passenger comfort and safety in addition to the passengers themselves. It is therefore desirable to reduce the footprint of this equipment to increase the space available for additional passengers whilst maintaining the functionality of this equipment.

### SUMMARY

The present disclosure is defined by the claims.

### BRIEF DESCRIPTION OF THE DRAWINGS

Non-limiting embodiments and advantages of the present disclosure will be best understood by reference to the following detailed description taken in conjunction with the accompanying drawings, wherein:

FIG. 1 shows a known aircraft galley unit;

FIG. 2 shows a known airline cart;

FIG. 3 shows an aircraft galley unit according to an embodiment;

FIG. 4 shows a compartment of the aircraft galley unit of FIG. 3;

FIG. 5 shows two aircraft galley units according to an embodiment;

FIG. 6 shows an example of space saving enabled by the present disclosure;

FIG. 7 shows a meal pack configuration according to an embodiment;

FIG. 8 shows an aircraft meal preparation and distribution procedure that may be implemented with an aircraft galley unit according to an embodiment; and

FIG. 9 shows a waste collection procedure that may be implemented with an aircraft galley unit according to an embodiment.

Like reference numerals designate identical or corresponding parts throughout the drawings.

### DETAILED DESCRIPTION OF THE EMBODIMENTS

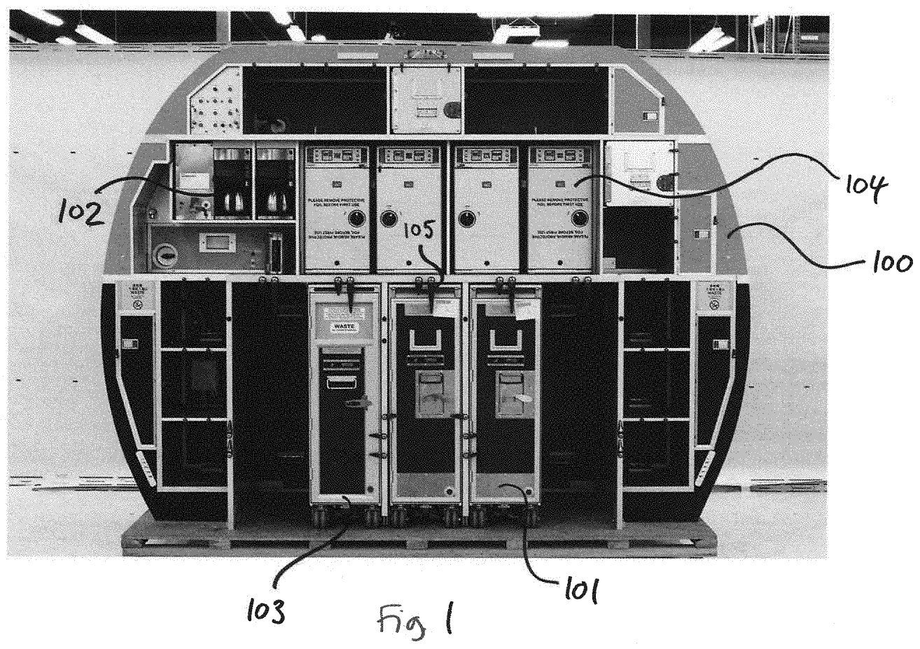

FIG. 1 shows a known aircraft galley unit 100. The unit 100 comprises one or more conventional airline carts 101, a conventional airline trash compactor 103 and food and/or drink preparation equipment including drink dispensers 102 and ovens 104.

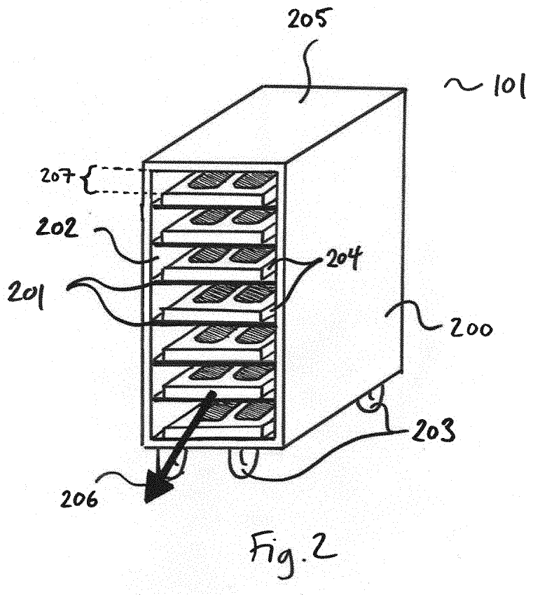

A problem with the unit 100 is that some of the space it occupies on the aircraft is not used efficiently, in particular, with the storage of meals for passengers. This is explained by FIG. 2, which shows the conventional airline cart 101 in more detail. The cart 101 comprises a housing 200 with wheels 203 which allow the cart to travel along the floor of an aircraft aisle. The housing 200 comprises a plurality of removable trays 201 onto which passenger meals 204 are placed (so each tray 201 holds two passenger meals 204). The trays 201 are placed in the housing prior to the cart being loaded onto an aircraft. Opposing inner walls (such as inner wall 202) of the housing 200 comprise grooves, ribs or the like (not shown) each for slidably engaging with an edge of a tray 201. This allows the plurality of trays to be held within the cart 101 and slid out of the cart in the direction of arrow 206 to be passed to passengers as the cart travels along the aircraft aisle. The top 205 of the housing 200 may comprise food, drink, cutlery, napkins or the like (not shown). The trays when initially loaded on the cart 101 do not include a hot meal container (not shown). A hot meal container is added to the tray at the point of serving each passenger and is also stored on the top 205 of the cart 101 (having previously been stored in a separate part of the galley unit 100 and heated up in the oven 104). When not in use, the cart 101 is securely stored (so it cannot roll on its wheels 203) in the unit 100 by pivoting arm 105.

A problem is that there is a lot of wasted space in the cart 101. In particular, space 207 between trays 201 not taken up by meals 204 is wasted. This includes the vertical clearance between the top of food items and the tray above and empty space on the tray reserved for a hot meal container. This results in a significant amount of wasted space, especially when there are a large number of meals to be served (and therefore a large number of carts 101 and trays 201). Also, the need to contain the meals 204 in the conventional airline cart 101 means the weight of the meals and cart is confined to being below work deck (counter top) height. This restricts changes that can be made to the construction of the known aircraft galley unit 101. There is therefore a need to overcome these problems.

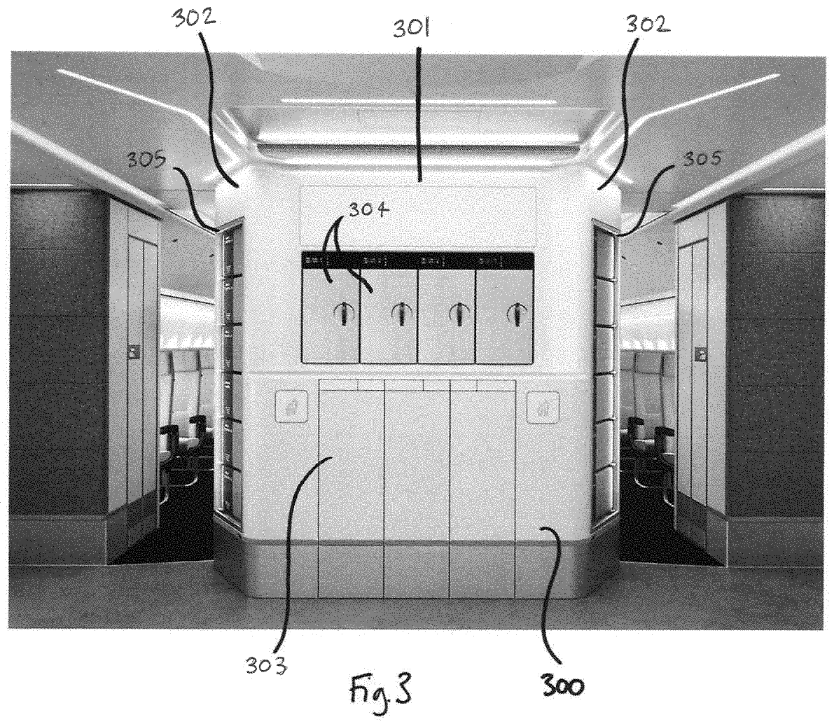

FIG. 3 shows an aircraft galley unit 300 according to an embodiment. The unit 300 comprises a first face 301, positioned at 90 degrees with respect to the direction of the aircraft aisles along which passengers travel to get to their seats, and two second faces 302, each positioned at less than 90 degrees with respect to the direction of an aisle along which passengers travel to get to their seats. The first face 301 comprises one or more trash compactors 303 and food and/or drink preparation equipment including ovens 304. The second faces 302 each comprise a compartment 305 configured to receive carrier boxes (the carrier boxes being food containers which can be lifted and carried by airline staff). The first face 301 is between the second faces 302 in this example.

With the food and/or drink preparation equipment located on the same face (the first face 301), all such equipment is easily accessible without needing to move around the aircraft. Food and/or drink can therefore be prepared quickly and easily. The positioning of compartments 305 on second faces 302 that are each inclined towards an aisle allows easy access to each compartment from an aisle. This is particularly useful for loading and unloading carrier boxes from the compartment.

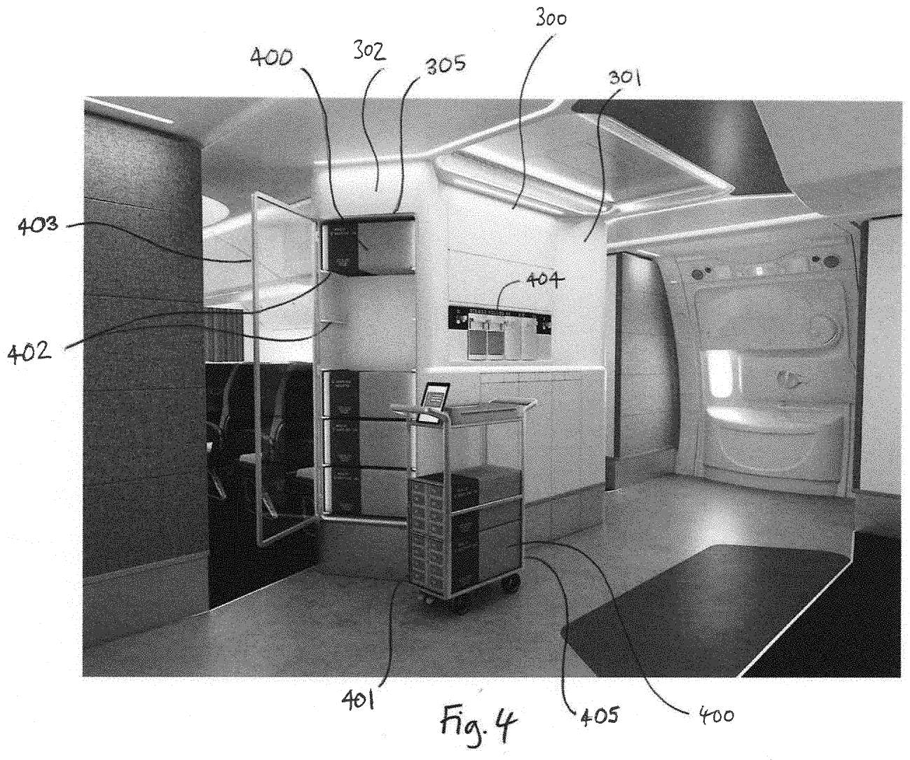

Storing passenger meal contents in carrier boxes in these compartments 305 rather than on trays in carts enables a significantly more efficient and flexible use of space. FIG. 4 shows a compartment 305 in more detail, containing carrier boxes 400. Each carrier box 400 contains a plurality of smaller containers, each smaller container containing at least some of the contents of a passenger meal. Each smaller container and its contents is referred to as a meal pack 401. The compartment 305 has a shape and size such that the carrier boxes 400 sit flush against the walls of the compartment to maximise space-efficiency. Opposing inner walls of the compartment comprise ribs 402 that support the carrier boxes 400 in a vertical arrangement, such that the carrier boxes may be removed in any order and do not crush each other. However, the present disclosure is not limited to this means of supporting the carrier boxes and other support structures (such as shelves or the like) positioned on any inner surface of the compartment 305 are conceivable. The use of ribs 402 rather than shelves is particularly desirable, however, since less material is required to create a rib compared to a shelf, thereby helping to reduce the weight carried by the aircraft. The compartment 305 may be refrigerated to ensure food stays fresh during the flight. When a plurality of compartments is present, one or more may be refrigerated. The compartment further comprises a door 403 that prevents carrier boxes falling out, for example in the event of turbulence, and insulates the carrier boxes from heat. The door 403 may be made of a transparent material (e.g. transparent plastic or safety glass), allowing the compartment contents to be viewed without opening it. In this embodiment, the food and/or drink preparation equipment on the first face of the galley unit comprise drink dispensers 404.

FIG. 4 also shows two carrier boxes 400 arranged on an airline cart 405. Unlike the conventional cart 101 in FIG. 1 and FIG. 2, cart 405 is configured to receive the carrier boxes rather than trays. Carrier boxes 400 are stored in compartments 305 from the beginning of the flight, and then loaded onto carts 405 when meals are to be distributed to passengers. One or more carts 405 may be stored in the base of aircraft galley unit 300 in a collapsed form for the majority of the flight (thereby saving space) and then retrieved when needed by the crew.

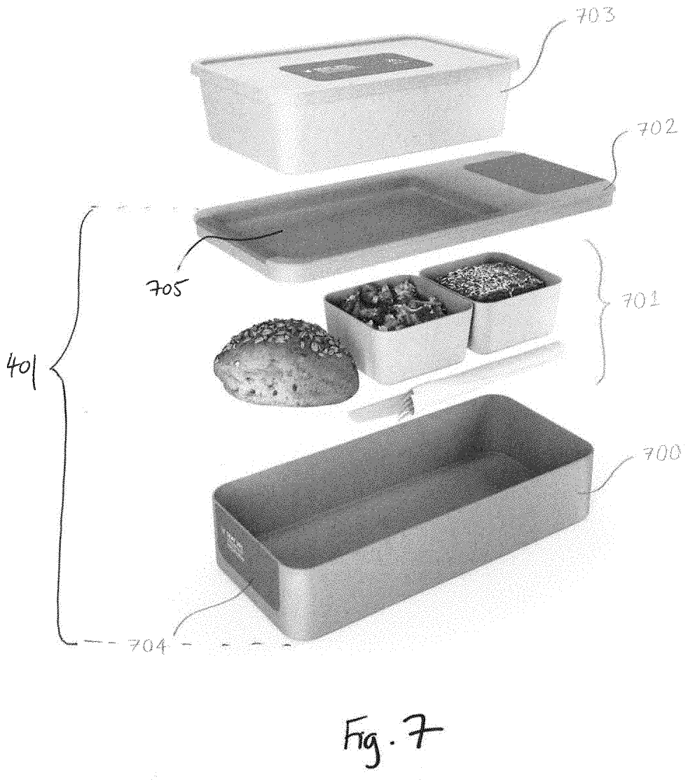

As passenger meal contents are enclosed in boxes to form meal packs 401 within larger carrier boxes 400 rather than placed on trays, space is saved when the meals are stored in a compartment and arranged on a cart. If the meal packs 401 have a shape (e.g. cuboidal) and size such that they sit flush against the walls of the carrier boxes 400, which sit flush against the walls of the compartment, there will be very little wasted space between meal content in the compartment. Similarly, if the carrier boxes are arranged on a cart 405 such that they have very little space between them (for example, stacked directly on top of one another) there will be very little wasted space between meal content on the cart. The meal packs may be configured such that reserving empty space for a hot meal container (as seen on conventional trays 201) is not necessary, reducing the wasted space even further. Meal pack configurations that achieve this are further discussed with regard to FIG. 7 below.

Storing carrier boxes 400 in a compartment 305 before loading them onto an airline cart for distribution to passengers has the advantage that the same cart may be re-used. As a result, fewer carts are required to distribute meals to the same number of passengers. Therefore less space is taken up and less weight is added by airline carts on the aircraft overall. The small size and self-contained nature of meal packs 401 further facilitate this process by allowing them to be moved and arranged more easily than trays.

The carrier boxes 400 have a shape (e.g. cuboidal), size and weight (when filled with meal packs 401) which allows them to be vertically stacked and which allows meal content to be handled in smaller amounts than is possible with conventional airline carts 101. Compared to the carrier boxes 400, conventional airline carts 101 are larger and heavier and cannot be stacked. They must therefore be accommodated below counter top height in the known aircraft galley unit 100, limiting changes to the shape and size of the known aircraft galley unit 100. On the other hand, by repackaging passenger meals into smaller elements (that is, meal packs 401 within carrier boxes 400), they can be handled and stored differently (namely, by lifting and vertical stacking), allowing the aircraft galley unit 300 of the present disclosure to configured in a new way.

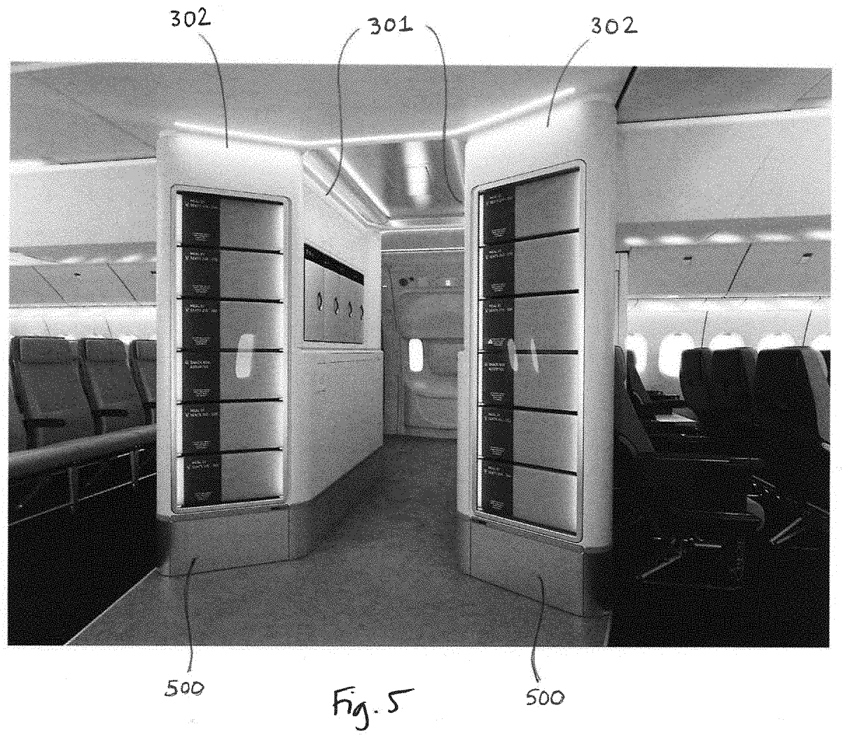

FIG. 5 shows two galley units according to an embodiment of this disclosure. The two units are positioned such that the first faces 301 of each are positioned facing each other and each at 90 degrees with respect to the direction of the aircraft aisles along which passengers travel to get to their seats. The second faces 302 of each are inclined towards an aisle, at less than 90 degrees with respect to the direction of the aisle along which passengers travel to get to their seats. This configuration of the two units allows a compartment from each unit to be easily accessible from the aisle whilst leaving sufficient space between them to manoeuvre one or more airline carts. In this embodiment, the area beneath each compartment comprises a space 500 for additional storage which may be used to store a cart 405. The cart 405 may be collapsible when not in use, thereby allowing the spaces 500 to be made smaller and thus saving further space on the aircraft.

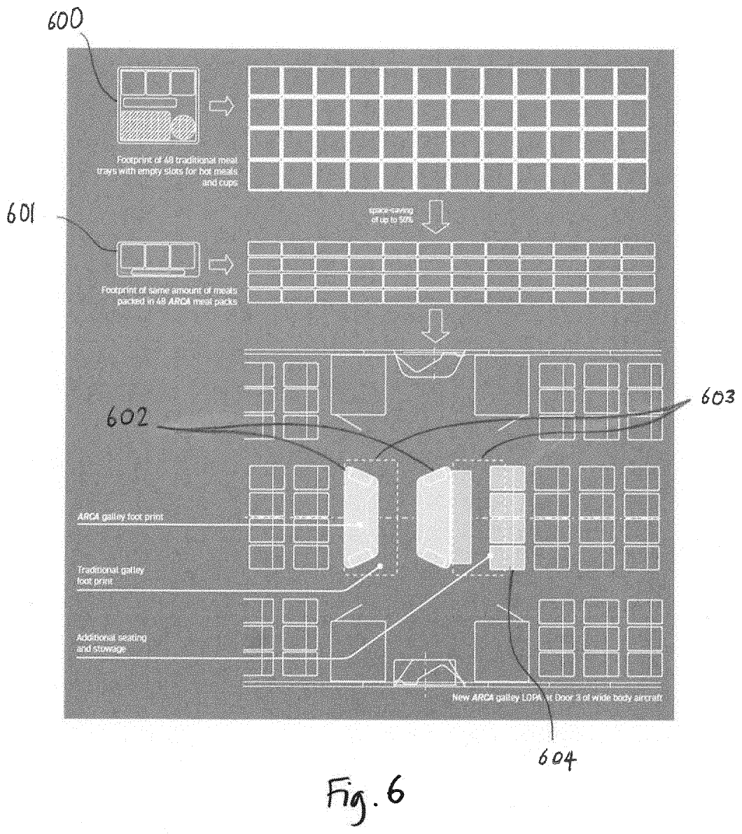

FIG. 6 demonstrates some of the space saved when the meal packs of the present disclosure are used by showing a comparison between the space occupation (or ‘footprint’) 600 of a conventional meal tray 201 and the footprint 601 of a meal pack 401. Due to this saved space, the galley unit 300 has a smaller footprint 602 compared to the footprint 603 of a known aircraft galley unit 100. It is clear that using two galley units 300 (in the configuration shown in FIG. 5) rather than two known galley units 100 results in considerable space being saved overall, which additional seating 604, stowage and/or one or more additional destination features may occupy.

In FIG. 7 the components of a meal pack 401 are shown. These comprise a main container 700 in which to fit a portion contents 701 of a passenger meal and a lid 702 (the main container 700 and lid 702 forming the overall container of the meal pack 401). The lid is configured such that a hot food container 703 may be positioned on top without sliding off when the lid is tilted or displaced. This effect may be achieved, for example, where the lid includes an indentation 705 configured to receive a base of the hot food container 703 such that the base of the hot food container sits flush within the indentation thereby holding the hot food container securely in place. A hot food container (temporarily stored on top of the cart 405 as meals are served, for example) can therefore added to the meal at the point of serving each passenger without needing an empty space reserved for it in the meal pack. Meal packs 401 are a size and shape such that they can be stacked and sit flush against the walls of carrier boxes 400 so that empty space around them is minimized when arranged on a cart or compartment. As previously mentioned, these features make the meal pack more space-efficient than conventional trays by reducing wasted space.

Meal pack contents 701 comprise food, for example some of the components of a conventional passenger meal 204 (such as a side dish, dessert and bun), as well as accessories such as napkins and cutlery. The contents may be customisable for each passenger, allowing passengers to only receive foods of their choice. This reduces the risk of producing large amounts of food waste. For personalised meals to be distributed to the correct passengers, information that identifies a meal pack may be provided with each, for example by means of a label 704 attached to the main container 700.

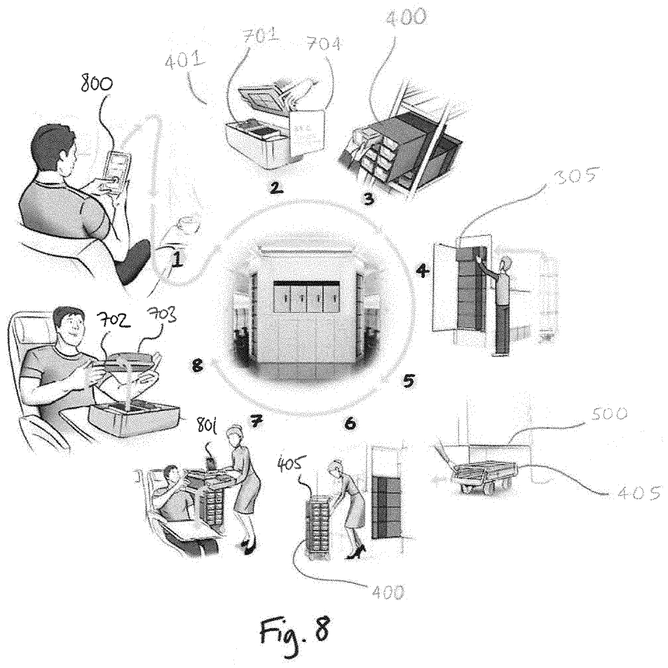

FIG. 8 shows an aircraft meal preparation and distribution procedure that may be implemented with the galley unit 300 according to an embodiment of this disclosure. Step 1 shows a passenger choosing their seat and configuring their meal as they book their flight using a suitable electronic device 800 (e.g. smartphone). In step 2, the order is transferred to a catering company and a meal pack 401 is prepared with customised contents 701 and a distinguishing label 704. In step 3, all meal packs for that flight are stacked in seat order within carrier boxes 400. A loading rack holds all carrier boxes for one galley and helps transport these carrier boxes onto the aircraft. In step 4, the carrier boxes are stored in refrigerated compartments 305 of the galley. The loading rack stays with the catering facility (so is removed from the aircraft before the flight, thereby saving additional space). Step 5 shows a member of the crew retrieving a collapsible cart 405 from an additional storage space 500 in the base of the galley unit 300 when meal service begins. In step 6, the cart is loaded with three carrier boxes 400 (in this embodiment, 48 meal packs in total, each carrier box 400 storing 16 meal packs 401). Hot food containers 703 (not shown) are also added to the top of the cart. In step 7 the crew start meal service, optionally aided by a suitable electronic device 801 which indicates which hot meal is to be added to each meal pack for each passenger (according to the passenger's previous meal selection). They retrieve the meal pack for each seat and attach a hot food container, which attaches securely onto the lid of the pack. In step 8 it is shown how the lid of the meal pack then acts as a tray for the hot meal, so that there is no need for the passenger to directly touch the hot meal (thereby reducing the risk of the passenger scalding themselves).

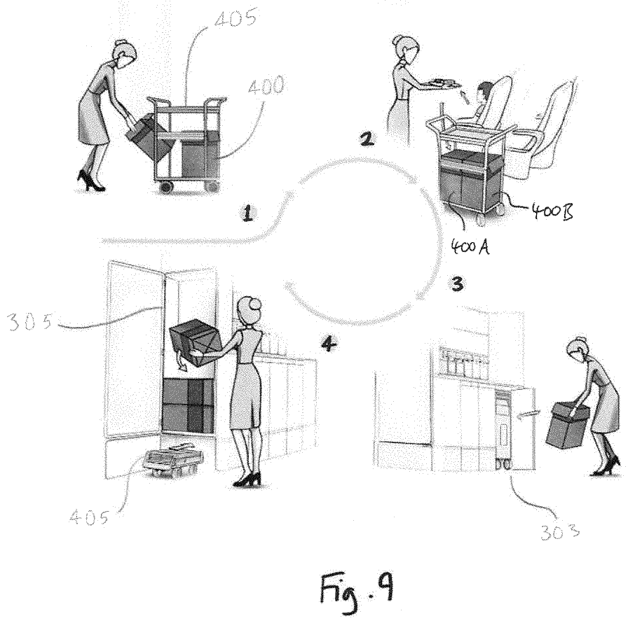

After the distribution of meals to passengers there will later be a waste collection procedure. FIG. 9 shows such a procedure that follows the events of FIG. 8. In FIG. 9, step 1 demonstrates how (now empty) carrier boxes 400 are placed on the same cart 405 as before in order to be re-purposed for waste collection. In step 2, the crew separates the waste at the point of collection. For example, recyclable waste may be collected in carrier box 400A and compostable waste may be collected in carrier box 400B. In step 3, back at the galley, these carrier boxes fit into the trash compactor 303 (the carrier boxes being shaped and sized to act as a trash compactor receptacle for existing airline trash compactors, for example, thereby allowing the galley unit 300 to be compatible with existing airline trash compactors) that reduces the volume of the collected waste for efficient stowage during the remainder of the flight. Carrier boxes containing compostable waste (e.g. carrier box 400B) may be stored in a storage section (not shown) of the trash compactor 303 in the usual way. Carrier boxes containing recycling waste (e.g. carrier box 400A) may be returned to one of the (now empty) compartments 305. Step 4 shows how an empty compartment 305 may be used to store carrier boxes filled with recyclable waste. The empty carrier boxes 400 may also be used to store the main containers 700 and lids 702 of the meal packs 401 in the compartments 305 after they have been used (e.g. with the recyclable waste). In an example, the main containers 700 are stackable and will be empty after use (the contents 701 having been eaten and the waste having been collected). This allows the main containers 700 and lids 702 to be stored in a smaller number of carrier boxes 400 than when they were initially loaded on the plane (the remaining carrier boxes 400 therefore being used for waste collection). The cart 405 is then collapsed and stowed away. As a result of this process, all available space is used efficiently and at the destination caterers can easily identify and remove the different types of waste.

In an embodiment, the carrier boxes 400 and main containers 701 and lids 702 of the meal packs 401 are made from recyclable, reusable or compostable material (e.g. cardboard) to reduce landfill.

Some embodiments of the present technique are defined by the following numbered clauses:

1. An aircraft galley unit comprising a compartment configured to receive airline cart food containers, wherein a shape and size of the compartment is such that the airline cart food containers are vertically arrangeable in the compartment and sit flush against the walls of the compartment.
2. An aircraft galley unit according to clause 1, wherein the compartment comprises supports configured to support each airline cart food container.
3. An aircraft galley unit according to clause 2, wherein the supports comprise ribs each configured to support an edge of one of the airline cart food containers.
4. An aircraft galley unit according to any preceding clause, wherein the compartment comprises a door.
5. An aircraft galley unit according to any preceding clause, wherein the compartment is refrigerated.
6. An aircraft galley unit according to any preceding clause comprising a first face and a second face, wherein:

in use, the first face is positioned at 90 degrees with respect to a direction of travel along an aircraft aisle and the second face is positioned at less than 90 degrees with respect to the direction of travel along the aircraft aisle;

the first face comprises food and/or drink preparation equipment; and

the second face comprises the compartment.

7. An aircraft galley unit according to clause 6, wherein:

the compartment is one of a plurality of compartments of the aircraft galley unit and the second face is one of a plurality of second faces of the aircraft galley unit, each second face comprising a respective one of the compartments; and

the first face is positioned between two of the second faces.

8. An aircraft galley unit according to any preceding clause, wherein the airline cart food containers are removable from the compartment and loadable on an airline cart.
9. An aircraft galley unit according to any preceding clause, wherein the airline cart food containers are insertable in an airline trash compactor.
10. An aircraft galley unit according to any preceding clause, wherein each airline cart food container comprises a plurality of meal packs.

Numerous modifications and variations of the present disclosure are possible in light of the above teachings. It is therefore to be understood that within the scope of the appended claims, the disclosure may be practiced otherwise than as specifically described herein.

Although the present disclosure has been described in connection with some embodiments, it is not intended to be limited to the specific form set forth herein. Additionally, although a feature may appear to be described in connection with particular embodiments, one skilled in the art would recognize that various features of the described embodiments may be combined in any manner suitable to implement the technique.

1. An aircraft galley unit comprising a compartment configured to receive airline cart food containers, wherein a shape and size of the compartment is such that the airline cart food containers are vertically arrangeable in the compartment and sit flush against the walls of the compartment.

2. An aircraft galley unit according to claim 1, wherein the compartment comprises supports configured to support each airline cart food container.

3. An aircraft galley unit according to claim 2, wherein the supports comprise ribs each configured to support an edge of one of the airline cart food containers.

4. An aircraft galley unit according to claim 1, wherein the compartment comprises a door.

5. An aircraft galley unit according to claim 1, wherein the compartment is refrigerated.

6. An aircraft galley unit according to claim 1 comprising a first face and a second face, wherein:
in use, the first face is positioned at 90 degrees with respect to a direction of travel along an aircraft aisle and the second face is positioned at less than 90 degrees with respect to the direction of travel along the aircraft aisle;
the first face comprises food and/or drink preparation equipment; and
the second face comprises the compartment.

7. An aircraft galley unit according to claim 6, wherein:
the compartment is one of a plurality of compartments of the aircraft galley unit and the second face is one of a plurality of second faces of the aircraft galley unit, each second face comprising a respective one of the compartments; and
the first face is positioned between two of the second faces.

8. An aircraft galley unit according to claim 1, wherein the airline cart food containers are removable from the compartment and loadable on an airline cart.

9. An aircraft galley unit according to claim 1, wherein the airline cart food containers are insertable in an airline trash compactor.

10. An aircraft galley unit according to claim 1, wherein each airline cart food container comprises a plurality of meal packs.
